(19) United States
(12) Patent Application Publication
(10) Pub. No.: US 2004/0017484 A1
(43) Pub. Date: Jan. 29, 2004

(54) Recording/reproducing apparatus and power supply method

(75) Inventor: Akira Tagawa, Fukaya-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/452,582

(22) Filed: Jun. 3, 2003

(30) Foreign Application Priority Data
Jul. 26, 2002 (JP) 2002-218429

(51) Int. Cl. H04N 5/225

(52) U.S. Cl. 348/207.99

(57) ABSTRACT

Sound inputted via a sound input section is recorded in a memory via a DSP. The sound recorded in the memory is reproduced by a sound output section. A camera section photographs a subject, and records still image data of the subject in the memory. A mode transfer control section turns off a switch to partially stop a power supply to each section of the recording/reproducing apparatus and sets an operation mode of the apparatus to a standby mode, when the operation of the recording/reproducing apparatus stops and a stop state continues for a predetermined time. When any button of the operation section is pressed in the standby mode, the switch is turned on, the power supply stopped in the standby mode is resumed, and a process such as still image recording is executed in accordance with the pressed button.

### CROSS-REFERENCE TO RELATED APPLICATIONS

This application is based upon and claims the benefit of priority from the prior Japanese Patent Application No. 2002-218429, filed Jul. 26, 2002, the entire contents of which are incorporated herein by reference.

### BACKGROUND OF THE INVENTION

1. Field of the Invention

The present invention relates to a recording/ reproducing apparatus for recording/reproducing digital data such as sound and image on/from a recording medium.

2. Description of the Related Art

In a sound recording/reproducing apparatus (hereinafter referred to as a memory recorder) in which a solid state memory is used as a recording medium, when a non-operation period of time of all the buttons on the memory recorder driven mainly by a battery, continues for three minutes, e.g., a standby mode is automatically set for energy saving, thus a power consumption of the apparatus is reduced.

The standby mode is changed to the recording mode with a recording button operation to start the recording. Moreover, a reproducing mode is achieved with a reproducing button operation to start the reproducing. Moreover, a stop button is operated to obtain a stop mode and the operation of the apparatus stops.

Moreover, there is an apparatus in which a camera module of an attachable/detachable type is connected to the memory recorder and a still image can be picked up.

In the memory recorder to which the camera module is connected and in which the still image can be recorded, the still image cannot be recorded in the standby mode. To record the still image in the standby mode, firstly the stop button has to be operated to supply power to the memory recorder and to bring the recorder into the stop mode. Subsequently, a release (shutter) button on the camera module is operated to record the still image, and there is a possibility that a shutter chance is missed.

### BRIEF SUMMARY OF THE INVENTION

According to one aspect of the present invention, there is provided recording/reproducing apparatus, comprising: a recording/reproducing section which records information in a recording medium and which reproduces the recorded information; an operation section including various buttons which operates the recording/reproducing section; a judgment section to judge whether or not a stop state continues for a predetermined time, when the operation of the recording/reproducing apparatus stops; a mode setting section which sets an operation mode of the recording/reproducing apparatus in response to the button operated in the operation section and which partially stops a power supply to the recording/reproducing apparatus and sets the operation mode of the apparatus to a standby mode, when the stop state continues for the predetermined time; a first power supply section which supplies a power to a part of the recording/reproducing apparatus regardless of the operation mode determined by the mode setting section; a detection section which detects that any button of the operation section has been operated in the standby mode; a second power supply section which restarts the power supply stopped in the standby mode, when the detection section detects that any button of the operation section has been operated; and an execution section which uses one of the recording section and reproducing section to execute a process corresponding to the button operated in the standby mode.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a recording/reproducing apparatus according to one embodiment of the present invention;

FIG. 2 is a flowchart showing a main process;

FIG. 3 is a flowchart showing a camera data control;

FIG. 4 is a flowchart showing a process in a standby mode;

FIG. 5 is a block diagram showing the constitution of a second embodiment according to the present invention;

FIG. 6 is a flowchart showing a camera data process according to the present embodiment:

FIG. 7 is a block diagram showing the constitution of a third embodiment of the present invention; and

FIG. 8 is a block diagram showing the constitution of a fourth embodiment of the present invention.

### DETAILED DESCRIPTION OF THE INVENTION

Embodiments of the present invention will be described in detail with reference to the drawings. The following description relates to the embodiments of the present invention, and does not limit the apparatus or method of the present invention.

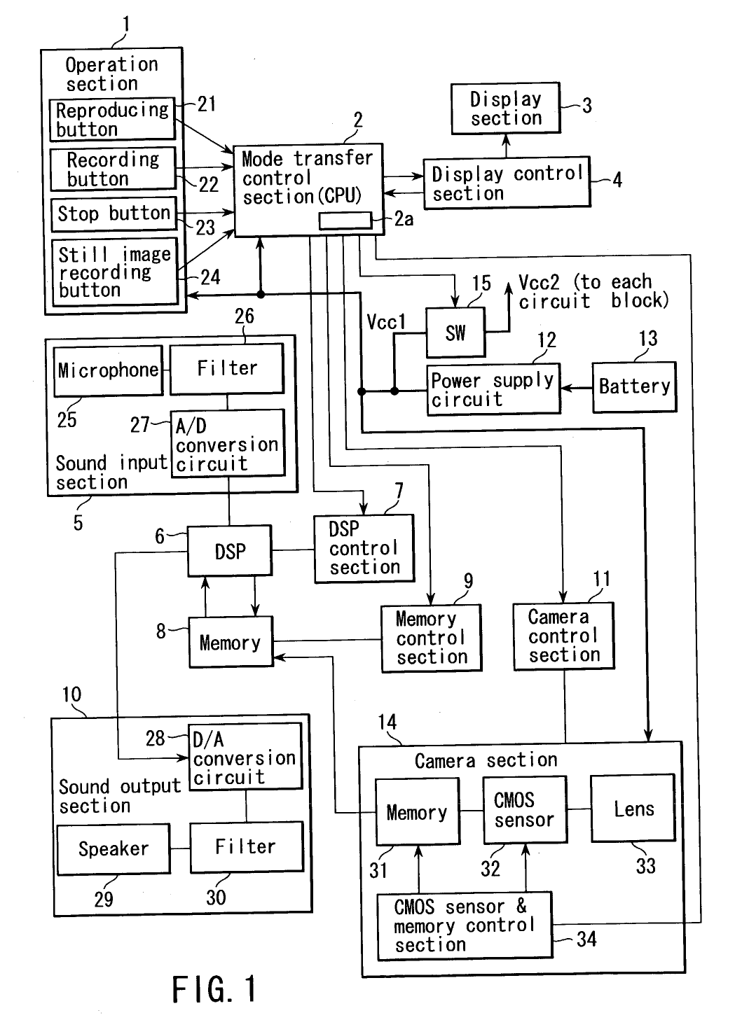

FIG. 1 is a block diagram showing the constitution of one embodiment of a recording/reproducing apparatus according to the present invention. Here, a constitution example of the recording/reproducing apparatus will be described in which a semiconductor memory 8 such as a flash memory is used as a recording medium. The recording/reproducing apparatus includes an operation section 1, mode transfer control section 2, display section 3, display control section 4, sound input section 5, DSP 6, DSP control section 7, memory 8, memory control section 9, sound output section 10, camera control section 11, power supply circuit 12, battery 13, and camera section 14.

The power supply circuit 12 generates a predetermined power supply voltage Vcc1 from the battery 13. The power supply circuit 12 functions as a power supply regulator. Even when an output voltage of the battery 13 changes with power consumption, a constant voltage is constantly generated.

When the operation of each section stops, and a non-operation period of time of all the buttons in the operation section 1 continues for a given time, to save energy of the battery 13, the mode transfer control section 2 turns off a switch 15 to stop the supply of a power supply voltage Vcc2 to each circuit. The apparatus is brought into a standby mode. During the standby mode, the power supply voltage Vcc1 is supplied to the operation section 1, mode transfer control section 2, and camera section 14. When any button of the operation section 1 is pressed during the standby mode, the mode transfer control section 2 detects that and turns on the switch 15, and the output voltage of the power supply circuit 12 is supplied to each circuit via the switch 15. The power supply voltage supplied via the switch 15 is here set to Vcc2. Therefore, the power supply voltage Vcc2 is supplied to all circuit blocks except the operation section 1, mode transfer control section 2, and camera section 14 via the switch 15.

The operation section 1 includes various operation buttons such as a reproducing button 21, recording button 22, stop button 23, and still image recording (shutter) button 24. For the operation section 1, when any button is depressed by a user, an on signal is supplied to the mode transfer control section 2 in response to the depressed button. For example, the operation section 1 includes an I/O port for detecting the on/off state of each button. When the mode transfer control section 2 reads the I/O port, each button is detected to be on/off.

On detecting the on signal of the reproducing button 21, recording button 22, stop button 23, or still image recording button 24, the mode transfer control section 2 outputs control signals for instructing the shift to the modes such as a reproducing mode, recording mode, stop mode, and still image recording mode to the display control section 4, DSP control section 7, memory control section 9, and camera control section 11.

A sound input section 5 includes a microphone 25, filter 26, and analog/digital conversion circuit (hereinafter referred to as the A/D conversion circuit) 27. The microphone 25 converts a sound to an analog sound signal, and supplies the signal to the filter 26. The filter 26 removes unnecessary very low and very high frequency components from the sound signal supplied from the microphone 25, and supplies the signal of a necessary band to the A/D conversion circuit 27. The A/D conversion circuit 27 converts the sound signal from the filter 26 to a digital sound signal, and supplies the signal to the DSP 6.

The display control section 4 allows the display section 3 to display a screen corresponding to the current mode based on the control signal of the mode transfer control section 2, and displays a free area of the memory 8. The DSP control section 7 gives instructions such as a reproducing instruction and stop instruction to the DSP 6 based on the control signal of the mode transfer control section 2. When the instruction from the DSP control section 7 is, for example, a sound recording instruction, the DSP 6 compresses/codes a digital sound signal from the sound input section 5, and supplies the signal as sound data to the memory 8. The memory 8 is a nonvolatile semiconductor memory such as a flash memory.

The memory control section 9 gives the instructions such as the reproducing instruction, recording instruction, and stop instruction to the memory 8 based on the control signal of the mode transfer control section 2. Under control of the memory control section 9, for example, the sound data from the DSP 6 is written in the memory 8, and the sound data stored in the memory 8 is read. The sound data read from the memory 8 is supplied to the DSP 6.

When the reproducing instruction is given to the DSP 6 from the DSP control section 7, the DSP subjects sound data or music data from the memory 8 to an extension process to prepare the digital sound signal, and supplies the signal to the sound output section 10.

The sound output section 10 is constituted of a digital/analog conversion circuit (hereinafter referred to as the D/A conversion circuit) 28, filter 30, and speaker 29. The D/A conversion circuit 28 converts the digital sound signal from the DSP 6 to an analog sound signal, and supplies the signal to the filter 30. The filter 30 removes the unnecessary very low and very high frequency components from the analog signal supplied from the D/A conversion circuit 28, and supplies the sound signal of a necessary band to the speaker 29. As a result, the speaker outputs sound.

The camera control section 11 outputs the recording instruction to the camera section 14 based on the control signal of the mode transfer control section 2. The camera section 14 records still image data obtained via a lens 33 in the memory 8. The camera section 14 is constituted of the lens 33, a CMOS sensor 32, a memory 31, and a CMOS sensor and memory control section 34. In response to the instruction from the camera control section 11, an optical signal incident upon the lens 33 is converted to an electric signal by the CMOS sensor 32, once recorded as the still image data in the memory 31, and thereafter written in the memory 8. The memory 31 is, for example, constituted of a SRAM.

Next the stop mode and standby mode in the present embodiment will be described. In the present recording/reproducing apparatus, each button of the operation section 1 also serves as a power supply button. When any button is depressed, the power is first supplied to all the circuit blocks. For example, when the stop button 23 is depressed during the recording or reproducing of the sound, or when the recording of the still image after the still image recording button 24 is depressed is finished, the operation of each circuit block stops, but the supply of the power supply voltages Vcc1 and Vcc2 to each circuit block is continuously performed for a predetermined time. In this manner, the power supply voltages Vcc1 and Vcc2 are supplied to each circuit block, and the operation of each circuit block stops. This state is referred to as the stop mode.

When the stop mode continues for the predetermined time, the supply of the power supply voltage Vcc2 is stopped, and the apparatus is brought in the standby mode. In the present embodiment, the power supply voltage Vcc1 is always supplied to the operation section 1, mode transfer control section 2, and camera section 14, as long as the battery 13 supplies the voltage in a defined range to the power supply circuit 12. The standby mode indicates a state in which the power supply voltage is supplied only to the operation section 1, mode transfer control section 2, and camera section 14. The power supply voltage is Vcc1 in this embodiment.

An operation of the present embodiment will be described hereinafter in detail with reference to flowcharts.

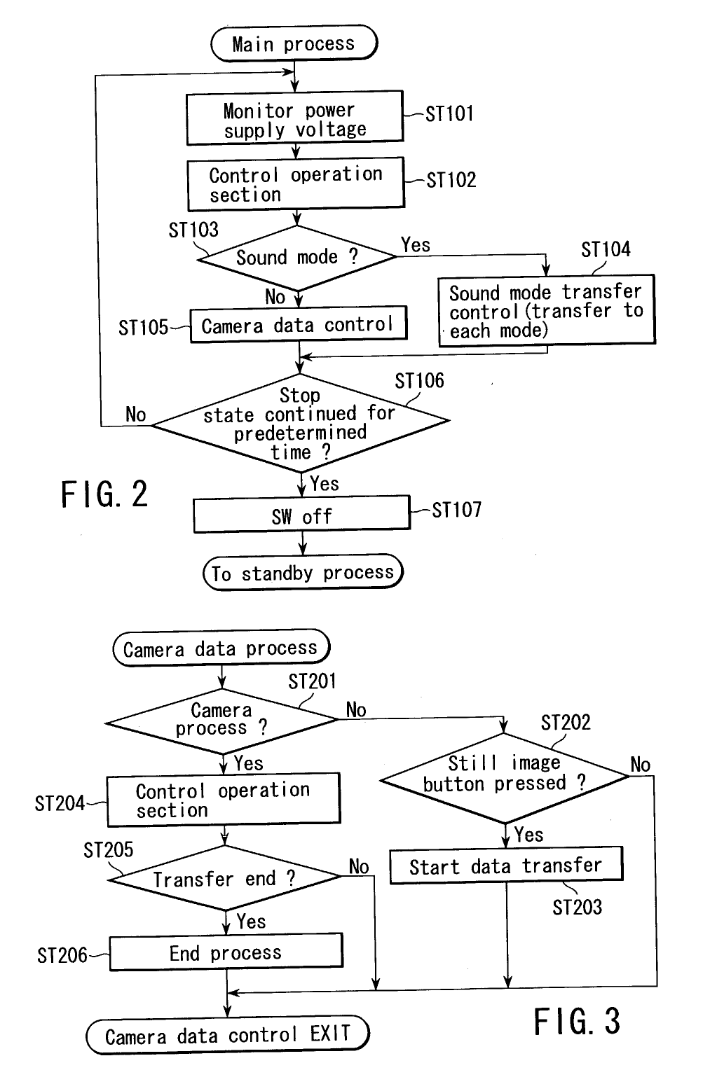

First, a main process will be described in a case in which the switch 15 is turned on under the control of the mode transfer control section 2 and the power is supplied to all the circuit blocks of the apparatus. FIG. 2 is a flowchart showing the main process. The mode transfer control section 2 monitors the power supply voltage of the battery 13 via the power supply circuit 12 (ST101). When the power supply voltage of the battery 13 is lower than a predetermined value, the mode transfer control section 2 displays that a battery voltage is low in the display section 3 via the display control section 4, and urges the user to change or charge the battery 13.

Next, the mode transfer control section 2 controls the operation section (ST102). That is, the mode transfer control section 2 judges whether any one of the respective buttons 21, 22, 23, 24 of the operation section 1 is pressed. In the case of any one of the respective buttons is pressed, the flow shifts to step ST103. When the button concerning the sound mode, that is, the reproducing button 21, recording button 22, or stop button 23 is pressed (YES in ST103), the flow shifts to step ST104.

A sound mode transfer control will be described hereinafter.

When the user presses the reproducing button 21 in the stop mode, the mode transfer control section 2 detects that, and outputs a command indicating the transfer to the reproducing mode to the DSP control section 7 and memory control section 9. The DSP control section 7 and memory control section 9 decode the command from the mode transfer control section 2 to a command which can be executed by the DSP 6 and memory 8, and output the command to the DSP 6 and memory 8.

The memory control section 9 reads the sound data from the memory 8 and sends the data to the DSP 6. The DSP 6 extends the compressed/coded sound data. The extended digital sound signal is converted to the analog sound signal by the D/A conversion circuit 28 of the sound output section 10, and further outputted from the speaker 29 via the filter 30.

When the user presses the recording button 22 in the stop mode, the mode transfer control section 2 detects that, and outputs the command indicating the shift to the recording mode to the DSP control section 7 and memory control section 9. The DSP control section 7 and memory control section 9 decode the command from the mode transfer control section 2 to the command which can be executed by the DSP 6 and memory 8, and output the command to the DSP 6 and memory 8. The DSP 6 compresses/codes the digital sound signal from the sound input section 5, and the compressed/coded sound data is recorded in the memory 8.

Next, the camera data control will be described.

When the button concerning the sound mode is not pressed in the operation section 1 (NO in step ST103), the flow shifts to the camera data control (ST105). FIG. 3 is a flowchart showing the camera data control.

When the camera section 14 is not transferring the still image data (NO in ST201), the mode transfer control section 2 judges whether or not the user has pressed the still image recording button 24. When the still image recording button 24 is pressed, the mode transfer control section 2 outputs the command indicating the shift to the still image recording mode to the memory control section 9 and camera control section 11. The memory control section 9 and camera control section 11 outputs the still image recording instruction to the memory 8 and camera section 14 respectively. At this time, for example, the memory control section 9 raises a state flag (not shown) indicating a transfer state. The camera section 14 starts recording the still image detected by the CMOS sensor 32 via the lens 33 in the memory 31 (ST203). The still image data recorded in the memory 31 is thereafter recorded in the memory 8. In this manner, the still image picked up by the CMOS sensor 32 is momentarily recorded in the high-rate operation memory 31 such as SRAM, and thereafter recorded in the low-rate operation memory 8 such as the flash memory. Accordingly, for example, continuous photography is possible.

When the camera section 14 is transferring the still image data (YES in step ST201), the mode transfer control section 2 controls the operation section (ST204). It is to be noted that this operation section control is similar to that in the step ST102, and can therefore be omitted. Next, the mode transfer control section 2 judges by the state flag whether or not the transfer of the still image data ends (ST204). When the transfer ends, an end process is performed (ST206). For example, in the end process, the mode transfer control section 2 displays a screen indicating the end of the still image transfer in the display section 3 via the display control section 4.

Turning back to the description of FIG. 2, after the stop button 23 is pressed, or the recording/reproducing of the sound or still image ends, the operation of each apparatus section stops, and the apparatus is brought in the stop mode (next to the camera data control of the step ST105), the mode transfer control section 2 judges whether the stop mode continues for a predetermined time (ST106). When the stop mode does not continue for the predetermined time (NO in step ST106), the flow returns to the step ST101, and the above-described process is repeated. When the stop mode continues for the predetermined time, to save the energy of the battery 13, the mode transfer control section 2 turns off the switch 15 to stop the supply of the power supply voltage Vcc2, and the apparatus shifts to the standby mode.

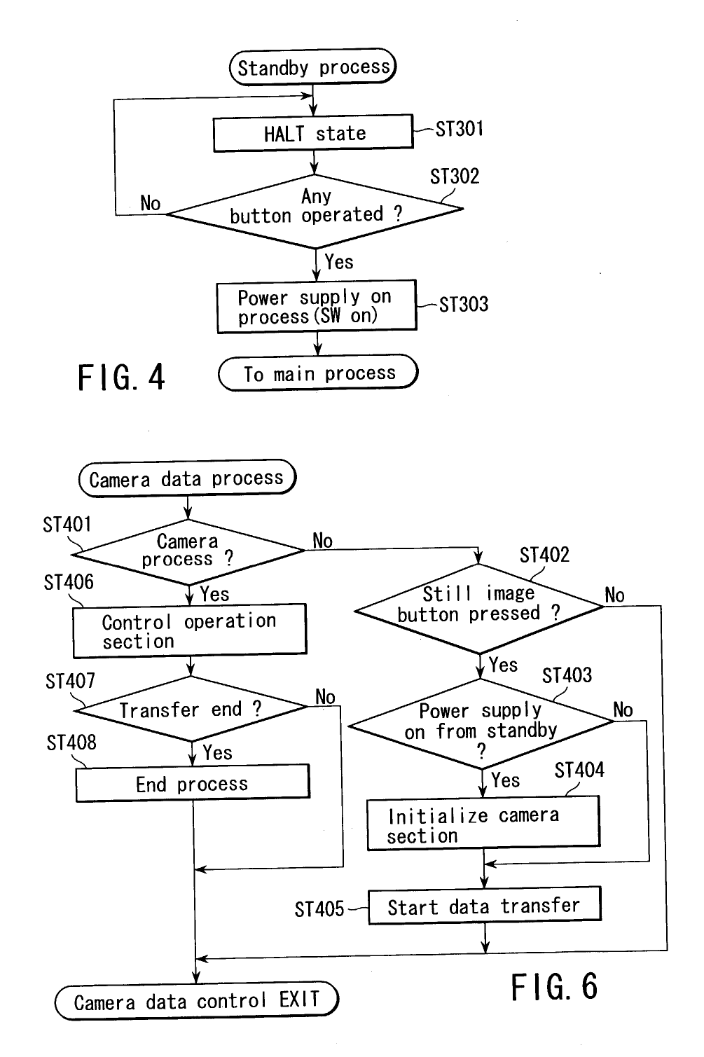

FIG. 4 is a flowchart showing the process in the standby mode. In the standby mode, CPU of the mode transfer control section 2 is set to a halt state, and the operation substantially stops (ST301). When the reproducing button 21, recording button 22, stop button 23, or still image recording button 24 of the operation section 1 is pressed in the standby mode (ST302), the CPU of the mode transfer control section 2 detects that by an interrupt process e.g., and the mode transfer control section 2 restarts the operation. At this time, the mode transfer control section 2 records the state of the I/O port of the operation section 1 (on/off state) in an internal memory 2a. Furthermore, the mode transfer control section 2 turns on the switch 15 and supplies the power supply voltage Vcc2 from the power supply circuit 12 to each circuit block (ST303).

In this manner, when any button of the operation section 1 is pressed, the standby mode is cancelled, and the flow shifts to the main process, the flow directly shifts to the process corresponding to the pressed button, that is, the step ST104 or ST105. At this time, the mode transfer control section 2 refers to the state of the I/O port recorded in the internal memory 2a to execute the step ST104 or ST105.

According to the present embodiment, even in the standby mode having a purpose of saving the energy, when any button such as the still image recording button is pressed, the corresponding process is instantly executed. Therefore, for example, a problem does not occur that a shutter change is missed.

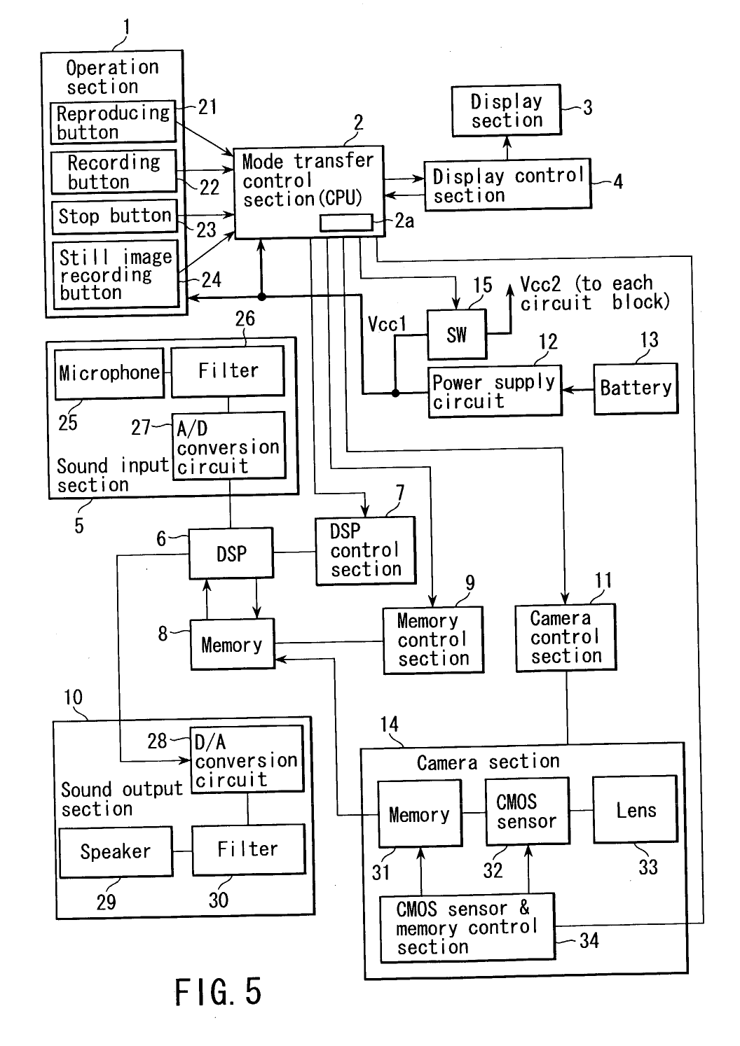

FIG. 5 is a block diagram showing the constitution of a second embodiment according to the present invention. In the present embodiment, blocks to which the power supply voltage Vcc1 is supplied in the standby mode are only the operation section 1 and mode transfer control section 2. To the camera section 14, Vcc2 is supplied via the switch 15. That is, when any button of the operation section 1 is pressed, the mode transfer control section 2 turns on the switch 15, and the power is supplied to all the circuit blocks including the camera section 14.

The operation of the present embodiment is similar to that of the first embodiment, the flow of a camera data process differs.

FIG. 6 is a flowchart showing the camera data process according to the present embodiment. The CMOS sensor 32 of the camera section 14 requires initialization of a white balance, when the power supply to the CMOS sensor turns on. Therefore, when the still image recording button 24 is pressed in the standby mode (in a state in which the power supply voltage Vcc1 is supplied only to the operation section 1 and mode transfer control section 2), as in steps ST402 to ST404, after supplying the power supply voltage Vcc2, the CMOS sensor is initialized by the CMOS sensor and memory control section 34 in the camera section 14. A time required for this initialization is, for example, several hundreds of milliseconds.

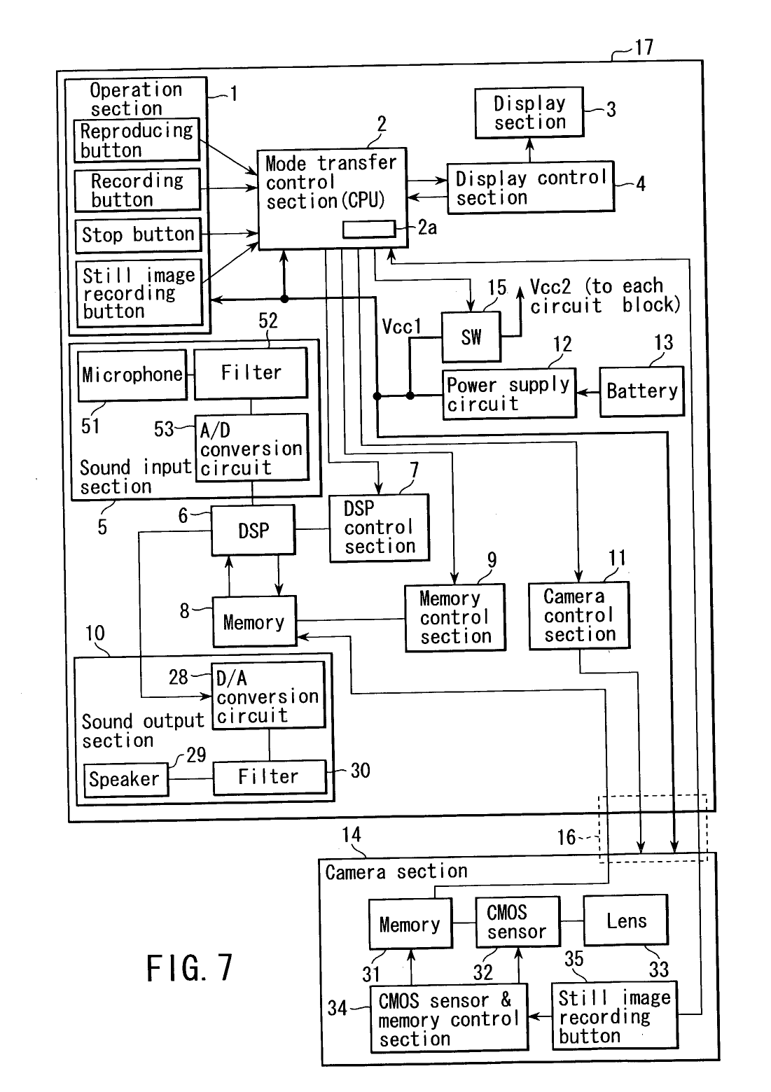

FIG. 7 is a block diagram showing the constitution of a third embodiment of the present invention. In the recording/reproducing apparatus according to the present embodiment, the camera section 14 is separated in structure from the main body. The camera section 14 is electrically connected to a recording/reproducing apparatus main body 17 by a connection portion 16. The connection portion 16 is constituted of only a connector, or the connector and a cable. When the recording/reproducing apparatus main body 17 is connected to the camera section 14 by the connector and cable, the camera section 14 can be disposed and used in a position apart from the main body 17. A still image recording button 35 is disposed in the camera section 14. Therefore, when the recording/reproducing apparatus main body 17 is inserted, for example, in a breast pocket, the camera section 14 is carried in a palm, and the still image recording button is operated. This way of use is also possible.

The operation of the present embodiment is similar to that of the first embodiment, but in the step ST102 in the main process of FIG. 2 and in the step ST302 in the standby process of FIG. 4, the pressing of the still image recording button 35 of the camera section 14 together with the buttons of the operation section 1 is detected.

When the user presses the still image recording button 35 in the camera section 14 in the stop mode or standby mode, the memory control section 9 and camera control section 11 output the still image recording instruction to the memory 8 and camera section 14, and the camera section 14 records the still image data in the memory 31 and stores the data in the memory 8. Therefore, even in the present embodiment, when the still image recording button 35 of the camera section 14 is pressed in the standby mode, the still image can be recorded.

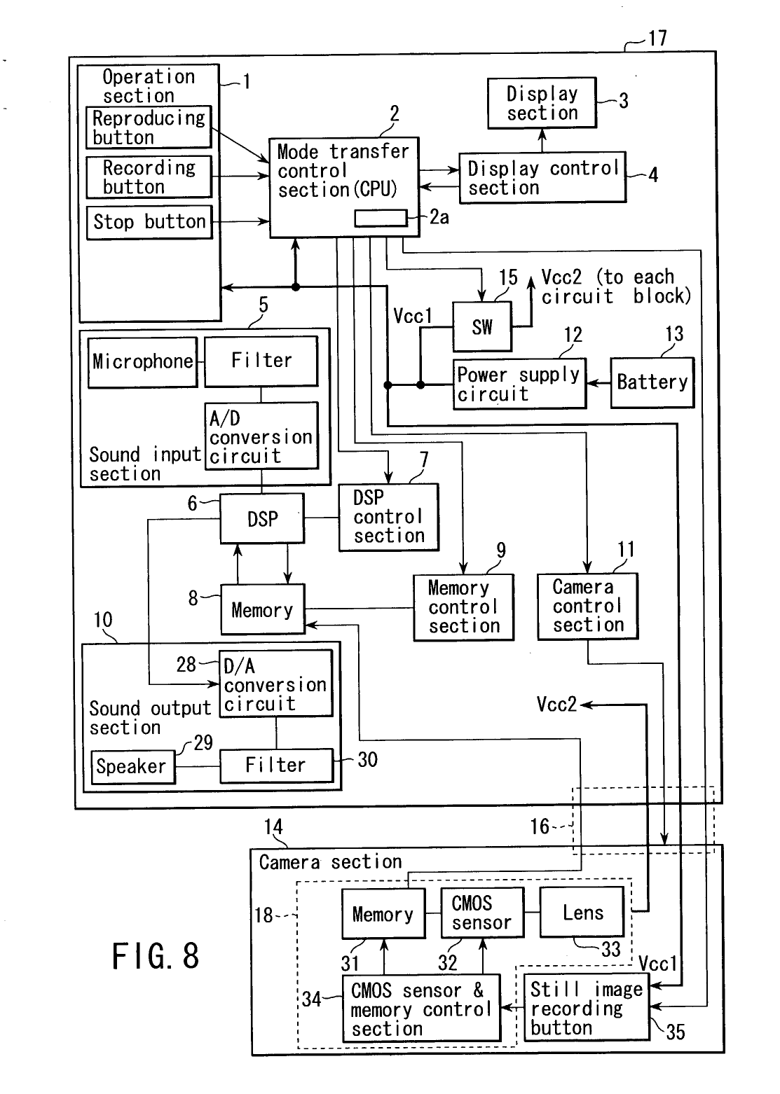

FIG. 8 is a block diagram showing the constitution of a fourth embodiment of the present invention. In the recording/reproducing apparatus according to the present embodiment, in the same manner as in the third embodiment, the camera section 14 is separated in structure from the main body, and the still image recording button 35 is disposed in the display control section 4.

The blocks to which the power supply voltage Vcc1 is supplied in the standby mode are the operation section 1, mode transfer control section 2, and still image recording button 35. To a main circuit block 18 of the camera section 14, Vcc2 is supplied via the switch 15. That is, when any button of the operation section 1 or the still image recording button 35 of the camera section 14 is pressed in the standby mode, the mode transfer control section 2 turns on the switch 15, and supplies the power to all the circuit blocks including the camera section 14. Moreover, when the still image recording button 35 is pressed in the standby mode, the camera section 14 initializes the CMOS sensor 32 and starts recording the still image in the same manner as in the second embodiment. Therefore, also in the present embodiment, the still image recording button 35 of the camera section 14 is pressed in the standby mode, and thereby the still image can be recorded.

When the non-operation state of the operation section 1 and the still image recording button 35 of the camera section 14 continues for a given time in the stop mode, the apparatus is brought into the standby mode in order to save the energy. When the still image recording button 35 on the camera section 14 is pressed in the standby mode, the mode transfer control section 2 controls the switch 15 to supply the power supply voltage Vcc2 to each circuit. Thus, the apparatus turns to the stop mode from the standby mode, and the still image is recorded. Therefore, the user operation is simplified as compared with the related art, and an opportunity of missing the shutter chance can be reduced.

In all the above-described embodiments, the memory 8 of the recording medium may be a semiconductor memory fixed to the recording/reproducing apparatus or an attachable/detachable memory card. Moreover, the apparatus for recording the sound and still image has been described, but the present invention can also be applied to the apparatus for recording/reproducing the sound and moving image.

Furthermore, the sound output section 10 may also output the sound or music via an earphone or headphone, in addition to the speaker 11.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A recording/reproducing apparatus which records and reproduces information, comprising:
a recording section which records the information in a recording medium;
a reproducing section which reproduces the information recorded in the recording medium;
an operation section including various buttons which operates the recording and reproducing sections;
a mode setting section which partially stops a power supply to the recording/reproducing apparatus and sets the operation mode of the apparatus to a standby mode, when the stop state continues for a predetermined time;
a first power supply section which supplies a power to a part of the recording/reproducing apparatus regardless of the operation mode determined by the mode setting section;
a detection section which detects that any button of the operation section is operated in the standby mode;
a second power supply section which restarts the power supply stopped in the standby mode, when the detection section detects that any button of the operation section has been operated; and
an execution section which uses one of the recording section and reproducing section to execute a process corresponding to the button operated in the standby mode.

2. The recording/reproducing apparatus according to claim 1, wherein the first power supply section supplies the power to at least the operation section and mode setting section.

3. The recording/reproducing apparatus according to claim 1, wherein the recording medium is a semiconductor memory.

4. The recording/reproducing apparatus according to claim 1, wherein the recording medium is an attachable/detachable memory card.

5. The recording/reproducing apparatus according to claim 1, wherein the information includes still image data.

6. The recording/reproducing apparatus according to claim 1, wherein the information includes one of still image data and moving image data, and sound data.

7. The recording/reproducing apparatus according to claim 1, wherein the information includes sound data, still image data, and moving image data.

8. A recording/reproducing apparatus which records and reproduces sound and which records a subject image, comprising:
a sound recording/reproducing section which converts sound to sound data to record the sound data in a recording medium and which reproduces sound data recorded in the recording medium;
a camera section which photographs a subject and which records still image data of the subject in the recording medium;
an operation section including various buttons which operates the sound recording/reproducing section and camera section;
a mode setting section which partially stops a power supply to the recording/reproducing apparatus and sets the operation mode of the apparatus to a standby mode, when the stop state continues for a predetermined time;
a first power supply section which supplies a power to at least the operation section and mode setting section regardless of the operation mode determined by the mode setting section;
a detection section which detects that any button of the operation section has been operated in the standby mode;
a second power supply section which restarts the power supply stopped in the standby mode, when the detection section detects that any button of the operation section has been operated; and
an execution section which uses one of the sound recording/reproducing section and camera section to execute a process corresponding to the button operated in the standby mode.

9. The recording/reproducing apparatus according to claim 8, wherein the first power supply section further supplies the power to the camera section.

10. A sound recording/reproducing device in a recording/reproducing system which comprises the sound recording/reproducing device and a camera section connected to the sound recording/reproducing device to photograph a subject and in which the sound recording/reproducing device and the camera section are separated in structure from each other, the sound recording/reproducing device comprising:
a sound recording/reproducing section which converts sound to sound data to record the sound data in a recording medium and which reproduces the sound data recorded in a recording medium;
an operation section which includes various buttons to operate the recording/reproducing apparatus;
a judgment section to judge whether an operation of the sound recording/reproducing device and camera section stops and a stop state continues for a predetermined time;
a mode setting section which sets an operation mode of the recording/reproducing apparatus in response to the button operated in the operation section and which partially stops a power supply to the recording/reproducing apparatus and sets the operation mode of the apparatus to a standby mode, when the stop state continues for the predetermined time;
a first power supply section which supplies a power to at least the operation section and mode setting section regardless of the operation mode determined by the mode setting section;
a detection section which detects that any button of the operation section has been operated in the standby mode;
a second power supply section which restarts the power supply stopped in the standby mode, when the detection section detects that any button of the operation section has been operated; and
an execution section which uses one of the sound recording/reproducing device and camera section to execute a process corresponding to the button operated in the standby mode.

11. The sound recording/reproducing device according to claim 10, wherein the first power supply section further supplies the power to the camera section.

12. A camera section in a recording/reproducing system which comprises a sound recording/reproducing section and the camera section connected to the sound recording/reproducing section to photograph a subject and in which the sound recording/reproducing section and the camera section are separated in structure from each other, the camera section comprising:
a photographing section which photographs the subject to provide still image data of the subject;
a first power supply line which supplies a power to the photographing section in accordance with an operation mode of the recording/reproducing system;
a still image recording button which determines a photographing timing of the subject; and
a second power supply line which supplies the power to the still image recording button regardless of the operation mode of the recording/reproducing system.

13. A recording/reproducing method in a recording/reproducing apparatus comprising a sound recording/reproducing section and a camera section which records a still image of a subject, the method comprising:
determining an operation mode of the recording/reproducing apparatus in response to a button operated in an operation section comprising various operation buttons including a still image recording button of the camera section;
judging whether an operation of the sound recording/reproducing section and camera section stops and a stop state continues for a predetermined time;
partially stopping a power supply to the recording/reproducing apparatus and setting the operation mode of the apparatus to a standby mode, when the stop state continues for the predetermined time;
detecting that any button of the operation section has been operated in the standby mode;
restarting the power supply stopped in the standby mode, when any button of the operation section is operated; and
executing a process corresponding to the button operated in the standby mode.
